(19) United States
(12) Patent Application Publication
(10) Pub. No.: US 2024/0353686 A1
(43) Pub. Date: Oct. 24, 2024

(54) Laser-Beam Homogenization or Shaping

(71) Applicant: KLA Corporation, Milpitas, CA (US)

(72) Inventors: Avner Safrani, Misgav (IL); Amir Aizen, Haifa (IL); Assaf Hacohen, Tel Aviv (IL); Stanislav Stepanov, Kfar Vradim (IL); Sylvi Haendel, Milpitas, CA (US); Ilia Lutsker, Kefar Sava (IL)

(21) Appl. No.: 18/633,983

(22) Filed: Apr. 12, 2024

Related U.S. Application Data
(60) Provisional application No. 63/460,030, filed on Apr. 18, 2023.

(51) Int. Cl. G02B 27/09; G02B 27/10; H01S 3/00

(52) U.S. Cl. CPC G02B 27/0944; G02B 27/0905; G02B 27/0994; G02B 27/1086; H01S 3/005

(57) ABSTRACT

A light source includes one or more deflection mirrors to deflect a laser beam at varying angles and diffractive optics to diffract the deflected laser beam. The light source also includes a multi-mode fiber to transmit the diffracted laser beam and a plurality of lenses, disposed between the diffractive optics and the multi-mode fiber, to provide the diffracted laser beam to the multi-mode fiber.

### TECHNICAL FIELD

This disclosure relates to light sources, and more specifically to turning a coherent light source (i.e., a laser) into an extended light source that is uniform (e.g., with both angular and spatial uniformity) or has specified shaping.

### BACKGROUND

In certain optical applications (e.g., in Koehler illumination microscopy), it is desirable to use an extended light source with angular and spatial uniformity. Such a light source should provide both a uniform field and a uniform illumination numerical aperture (NA). In laser-based applications, however, it is challenging to design a system with an extended light source that has both angular and spatial uniformity. Laser beams from commercially available lasers are very often collimated, with power distributions (i.e., profiles) that obey a Gaussian/Lorentzian-like distribution. In addition, the high degree of coherence of laser irradiation causes unwanted noisy speckle-pattern formation in the image and object planes. As a result, a laser beam by itself may not be a good choice as an extended uniform source.

One known technique for creating an extended light source uses a multi-lens array (MLA) or diffractive optical element (DOE) along with a simple lens to shape a Gaussian beam by creating a diffraction-orders pattern that is uniform or has some other designed profile. The resulting illumination is sparse, however: there is no light between the balanced diffraction orders. In the example of Koehler illumination microscopy, as this illumination is projected to the back aperture plane of the objective, the patterning results in angular non-uniformity at the object plane, such that the illumination NA is not continuous and uniform. Furthermore, dirt, scratches, and digs from the DOE surface are somewhat apparent in the object plane. In addition, because the light source is coherent, speckles are a problem.

Another known technique for creating a uniform extended light source uses a simple lens to couple a laser beam into a square fiber waveguide (i.e., a square core). Square fibers work as effective mode mixers. Because each point on a Gaussian beam is related to a propagating mode, mode-mixing in the fiber produces an output beam with angular uniformity. With a suitable core design, the number of modes is high and so the spatial uniformity at the fiber end-face is also high. The square shape of the core, however, complicates the design of the system by requiring either alignment of the end face of the core with respect to the imaging-system symmetry or the use of a large core to accommodate the circular geometry of optical apertures in the system. Square fibers also do not have a flexible NA range but instead are limited to a relatively large NA. In addition, the direct coupling does not resolve the speckle problem. Furthermore, a square fiber by itself provides limited uniformity. Finally, using direct coupling for high-energy lasers results in high power density in the core, which may result in laser-induced damage and coupling loss.

Yet another known technique for creating a uniform extended light source uses a Powell lens together with a standard diffuser. The Gaussian beam is fanned out and the cross-section of the dispersed beam is balanced. The resulting illumination spot size is quite large, however (e.g., at least a few millimeters, which is excessive for some designs). And speckles remain a problem.

### SUMMARY

Systems and methods are disclosed to produce an extended light source that is monochromatic and uniform (or alternatively, shaped by design). A coherent light source (i.e., laser) is turned into such an extended light source, which may have both angular and spatial uniformity. A uniform field and uniform illumination NA may thus be achieved, in accordance with some embodiments. Furthermore, the speckle from the coherent light source may be reduced and low light losses may be achieved (e.g., light losses may be minimized).

In some embodiments, a light source includes one or more deflection mirrors to deflect a laser beam at varying angles and diffractive optics to diffract the deflected laser beam. The light source also includes a multi-mode fiber to transmit the diffracted laser beam and a plurality of lenses, disposed between the diffractive optics and the multi-mode fiber, to provide the diffracted laser beam to the multi-mode fiber.

In some embodiments, an optical-illumination method includes generating a laser beam, deflecting the laser beam at varying angles, diffracting the deflected laser beam, providing the diffracted laser beam to a multi-mode fiber, and transmitting the diffracted laser beam through the multi-mode fiber.

### BRIEF DESCRIPTION OF THE DRAWINGS

For a better understanding of the various described embodiments, reference should be made to the Detailed Description below, in conjunction with the following drawings.

FIG. 1 shows a single-channel light source in accordance with some embodiments.

FIG. 2 shows an arrangement of components that compose a portion of the light source of FIG. 1, in accordance with some embodiments.

FIG. 3A is a graph showing a simulated spatial power distribution of the laser beam of FIG. 2 at the output of the multi-mode fiber (MMF) of FIG. 2 at a particular point in time.

FIG. 3B is a graph showing a simulated angular power distribution of the laser beam of FIG. 2 at the output of the MMF of FIG. 2.

FIG. 3C is a graph showing a simulated radiance cross-section corresponding to the angular power distribution of FIG. 3B.

FIG. 3D is a zoom-in view of the simulated spatial power distribution of FIG. 3A.

FIG. 4 is a schematic diagram of a multi-channel light source in accordance with some embodiments.

FIG. 5 is a flowchart illustrating a method of optical illumination in accordance with some embodiments.

FIG. 6A shows an image of a laser beam, as diffracted by a multi-lens array, in the plane of an end-face of an MMF.

FIG. 6B is an image in the Fourier Plane showing three different tilts of a deflection mirror.

FIG. 6C is an image at the far end-face of an MMF showing the spatial distribution of a laser beam for a single tilt of a deflection mirror.

FIG. 6D is an image showing the angular distribution of a laser beam for a single tilt of a deflection mirror.

FIG. 7A is a graph comparing angular uniformity for the light source for FIGS. 6A-6D with a light source that uses direct coupling without diffractive optics.

FIG. 7B is a graph comparing spatial uniformity for the light source for FIGS. 6A-6D with a light source that uses direct coupling without diffractive optics.

FIG. 8 shows an extended uniform light source in a Kohler illumination arrangement for microscopy in accordance with some embodiments.

Like reference numerals refer to corresponding parts throughout the drawings and specification.

### DETAILED DESCRIPTION

Reference will now be made in detail to various embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

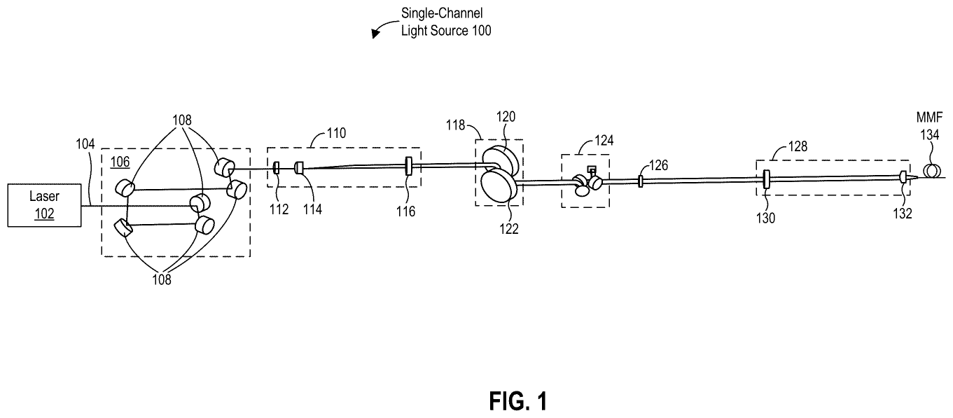

FIG. 1 shows a single-channel light source 100 in accordance with some embodiments. In the light source 100, a laser 102 generates a laser beam 104. The laser beam 104 does not have spatial or angular uniformity. Instead, the laser beam 104 has a Gaussian-like or Lorentzian-like profile. The light source 100 converts the laser beam 104 into a beam with substantial angular and spatial uniformity. The light source 100 thus may be a substantially uniform extended light source (i.e., a homogenized light source). Alternatively, the light source 100 shapes the laser beam 104 into a desired shape (in which case, the light source 100 is not homogenized).

In the light source 100, a beam-alignment assembly 106 receives the laser beam 104 from the laser 102 and aligns the laser beam 104 with downstream components of the light source 100, including a lens assembly 110 and one or more deflection mirrors 118. The beam-alignment assembly 106 includes a plurality of mirrors 108, which adjust an optical path (e.g., an optic axis) of the laser beam 104 to direct the laser beam 104 toward the lens assembly 110 and the one or more deflection mirrors 118. In some embodiments, the beam-alignment assembly 106 has six mirrors 108, which allow separate control of each degree of freedom. The six mirrors 108 may be configured as double orthogonal mirror assemblies and a tip/tilt mirror assembly. Alternatively, instead of a six-mirror assembly, the beam-alignment assembly 106 may have four mirrors or two mirrors (i.e., may be a four-mirror assembly or a two-mirror assembly).

The lens assembly 110, which may also be referred to as a zoom assembly, includes lenses 112, 114, and 116, which collectively adjust (e.g., increase) a size of the laser beam 104 and collimate the laser beam 104. In some embodiments, the lens assembly 110 adjusts the laser beam 104 so that its diameter has a specified value (e.g., a fixed value regardless of the original diameter of the laser beam 104 as generated by the laser 102). The lens assembly 110 is disposed between the beam-alignment assembly 106 and the one or more defection mirrors 118, and thus between the plurality of mirrors 108 and the one or more defection mirrors 118, along the optical path of the laser beam 104. The laser beam 104 as it exits the lens assembly 110 is resized and collimated, but is still non-uniform (e.g., still has a Gaussian-like or Lorentzian-like profile).

The one or more deflection mirrors 118 receive the laser beam 104, as resized and collimated by the lens assembly 110, and deflect the laser beam 104 at varying angles. By deflecting the laser beam 104, the one or more deflection mirrors 118 direct the laser beam 104 toward diffractive optics 126. In some embodiments, the one or more deflection mirrors 118 include a first mirror 120 and a second mirror 122, which together may be referred to as a scanning assembly. The first mirror 120 may be a first scanning mirror. For example, the first mirror 120 may be a fast-scanning mirror (FSM). (The term “fast-scanning mirror” is a known term of art. FSMs are commercially available.) Through the scanning action of the first scanning mirror, the first scanning mirror directs the laser beam 104 at different angles to different portions of the second mirror 122. The second mirror 122, which may be a second scanning mirror (e.g., a second FSM) or a static mirror (e.g., a right-angle mirror), directs the laser beam 104 toward the diffractive optics 126. In this manner, the two mirrors collectively direct the laser beam 104 toward the diffractive optics 126 at the varying angles and with varying spatial offsets. The varying angles and varying spatial offsets result in variation over time of the beam-projection position of the laser beam 104 on the diffractive optics 126. Using scanning mirrors for both the first mirror 120 and the second mirror 122, in accordance with some embodiments, allows both the angle of incidence and the beam-projection position of the laser beam 104 on the diffractive optics 126 to be controlled.

In some other embodiments, the one or more deflection mirrors 118 include only a single mirror, which may be tiltable. For example, the one or more deflection mirrors 118 may be a single tiltable right-angle mirror. This mirror projects the laser beam 104 onto the diffractive optics 126 (e.g., at different angles and beam-projection positions, resulting from varying the tilt of the mirror).

The diffractive optics 126 diffract the laser beam 104 (i.e., the laser beam 104 as deflected by the one or more deflection mirrors 118). In some embodiments, the diffractive optics 126 are a multi-lens array (MLA) that diffracts the laser beam 104. For example, the MLA may be a four-by-four, five-by-five, six-by-six, or seven-by-seven array of micro-lenses. Other array sizes are possible as well. The MLA may be a single-sided array of micro-lenses or a double-sided array of micro-lenses. Alternatively, the diffractive optics 126 are a diffractive optical element (DOE) that diffracts the laser beam 104. (The term “diffractive optical element” is a known term of art. DOEs are commercially available and can be custom-designed to provide a desired simulated beam profile.)

A plurality of lenses 128, including a projection lens 130 and a coupling lens 132, is disposed along the optical path of the laser beam 104 between the diffractive optics 126 and a multi-mode fiber (MMF) 134. The plurality of lenses 128, which may be referred to as an imaging assembly, provides the laser beam 104, as diffracted by the diffraction optics 126, to the MMF 134. The projection lens 130 collects and collimates (i.e., projects to infinity) the diffracted laser beam 104. The coupling lens 132 focuses the diffracted laser beam 104, as collimated by the projection lens 130, onto a first end-face of the MMF 134. The first end-face of the MMF 134 is positioned in a back focal plane of the coupling lens 132 (i.e., a focal plane of the coupling lens 132 situated downstream from the coupling lens 132 along the optical path of the laser beam 104). The coupling lens 132 thereby couples the laser beam 104 into the MMF 134.

In some embodiments, the MMF 134 is a large-core MMF 134, in that it has a larger core than MMFs used for network communications. For example, the core may be circular with a diameter in the range of 400 um to 1 mm. In another example, the MMF 134 may have a square core, for example with a width in the range of 400 um to 1 mm. Other examples of core shapes (e.g., hexagonal or octagonal) for the MMF 134 are possible. The laser beam 104 emerges from the MMF 134 at a second end-face that is at the opposite end of the MMF 134 from the first end-face. The laser beam 104 that emerges from the MMF 134 is the output of the light source 100. The laser beam 104 that emerges from the second end-face of MMF 134 may have substantial spatial and angular uniformity. Use of a non-circular core for the MMF 134 may improve the uniformity of the laser-beam 104 that emerges from the second end-face, as compared to a circular core. For example, a square core provides greater uniformity than a circular core (as do hexagonal and octagonal cores). Alternatively, the laser beam 104 has a specified non-uniform shape distinct from the beam profile of the laser beam 104 as generated by the laser 102. This specified non-uniform shape may be achieved, for example, by using a DOE designed to provide the non-uniform shape as the diffraction optics 126. The variation over time of the beam-projection position of the laser beam 104 on the diffractive optics 126 also mitigates speckle in the laser beam 104 by causing the speckles to average out over time. This variation of the beam-projection position also results in variation of the image position for the laser beam 104 in the MMF 134 over time, avoiding localized heating in the MMF 134 and therefore improving the lifetime of the MMF 134.

In some embodiments, the light source 100 further includes a beam-sampling assembly 124 that reflects a small fraction (e.g., 1% of the power) of the laser beam 104 toward a photodetector, thereby providing the reflected fraction of the laser beam 104 to the photodetector. The photodetector measures the power of the reflected fraction of the laser beam 104. Because the reflected fraction is a known fraction, the total power of the laser beam 104 is thereby determined and can be compared to the expected power to determine whether the laser 102 is on and whether the laser beam 104 has the expected power. The beam-sampling assembly 124 may be a two-window beam-sampling assembly in which a first fraction of the laser beam 104 is reflected through a first window and a second fraction of the laser beam 104 is reflected through a second window. The beam-sampling assembly 124 thus may produce a first reflection involving the first window and a second reflection involving the second window. The first window is situated in an opposite direction to the second window, such that the effects of the first and second reflections on the optical path of the unreflected laser beam 104 cancel each other out, leaving the optical path unperturbed. In the example of FIG. 1, the beam-sampling assembly 124 is disposed between the one or more deflection mirrors 118 and the diffractive optics 126. Other positions are possible; for example, the beam-sampling assembly 124 may be disposed between the lens assembly 110 and the one or more deflection mirrors 118 or between the laser 102 and the beam-alignment assembly 106 (e.g., right after an aperture of the laser 102).

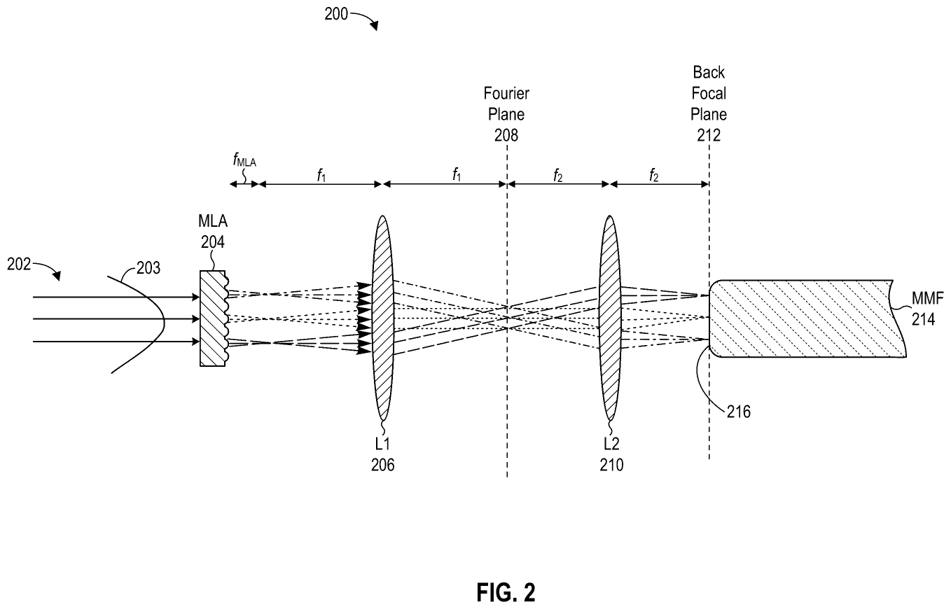

FIG. 2 shows an arrangement of components 200 that compose a portion of the light source 100 in accordance with some embodiments. The components 200 include an MLA 204, a first lens (L1) 206, a second lens (L2) 210, and an MMF 214. The MLA 204 is an example of the diffractive optics 126 (FIG. 1), the first lens 206 is an example of the projection lens 130 (FIG. 1), the second lens 210 is an example of the coupling lens 132 (FIG. 1), and the MMF 214 is an example of the MMF 134 (FIG. 1). The first lens 206 and the second lens 210 together are an example of the plurality of lenses 128 (FIG. 1). The first lens 206 is disposed between the MLA 204 and the second lens 210. The second lens 210 is disposed between the first lens 206 and an end-face 216 of the MMF 214. The end-face 216 is a near end-face of the MMF 214 (i.e., is an example of the first end-face of the MMF 134, FIG. 1).

The first lens 206 has a focal length f₁, the second lens 210 has a focal length f₂, and the MLA 204 has a focal length f_{MLA}. The first lens 206 is separated from the second lens 210 by a distance equal to the sum of f₁ plus f₂. This distance is a distance along the optic axis, and thus along the optical path, of a laser beam 202, which is an example of the laser beam 104 (FIG. 1). In this arrangement, the Fourier Plane 218 is both the back focal plane of the first lens 206 and the front focal plane of the second lens 210. The end-face 216 is separated from the second lens 210 by a distance equal to f₂ along the optic axis. The end-face 216 is thus disposed in the back focal plane 212 of the second lens 210. The MLA 204 is separated from the first lens 206 by a distance along the optic axis equal to the sum of f_{MLA} plus f₁.

The laser beam 202 is provided to the MLA 204 by the one or more deflection mirrors 118 (FIG. 1). At this point, the laser beam 202 is not uniform; in the example of FIG. 2, it has a Gaussian-like profile 203. Respective lenses of the MLA 204 sample light from respective positions in the laser beam 202 and direct the sampled light along various rays, as shown in FIG. 2. (For simplicity, FIG. 2 shows the propagation of rays from three micro-lenses in the MLA 204). Each point (corresponding to a respective diffraction order) in the Fourier Plane 208 is generated by combining rays from all of the micro-lenses in the MLA 204, as shown in FIG. 2 by the intersection of rays in the Fourier Plane 208. The points in the Fourier Plane 208 thus have equivalent energies. Furthermore, the rays for different points in the Fourier Plane 208 are projected to the back focal plane 212 with different respective projection angles. Multiple beams, each containing rays from each of the micro-lenses, are thus projected onto the back focal plane 212 (and therefore onto the end-face 216 of the MMF 214) at different angles. FIG. 2 shows three such beams. The beams have equivalent amplitudes, because they are associated with equivalent-power diffraction orders. The different-angled beams, as projected onto the end-face 216 of the MMF 214, generate different modes in the MMF 214. The arrangement of the components 200 in FIG. 2 thus balances the amplitudes of the modes, thereby obtaining substantial angular uniformity at the far end-face (i.e., the output) of the MMF 214. The far end-face is an example of the second end-face of the MMF 134 (FIG. 1).

The position of the laser beam 202 on the MLA 204 and the angles at which the MLA 204 receives the laser beam 202 vary in accordance with the operation (e.g., the scanning action) of the one or more deflection mirrors 118. As a result, the diffraction pattern generated by the MLA 204 shifts across the back focal plane 212 and thus across the end-face 216 of the MMF 214, further contributing to the achievement of substantial uniformity of the laser beam 202 as output by the MMF 214, for example by mitigating speckling. The shifting of the diffraction pattern also reduces localized heating in the MMF 214, thereby improving the lifetime of the MMF 214.

In the example of FIG. 2, the MLA 204 is shown as a single-sided MLA. The MLA 204 may alternatively be a double-sided MLA or may be replaced with a DOE. The DOE may be positioned in the front focal plane of the first lens 206 (i.e., separated from the first lens 206 by a distance f₁ along the optic axis).

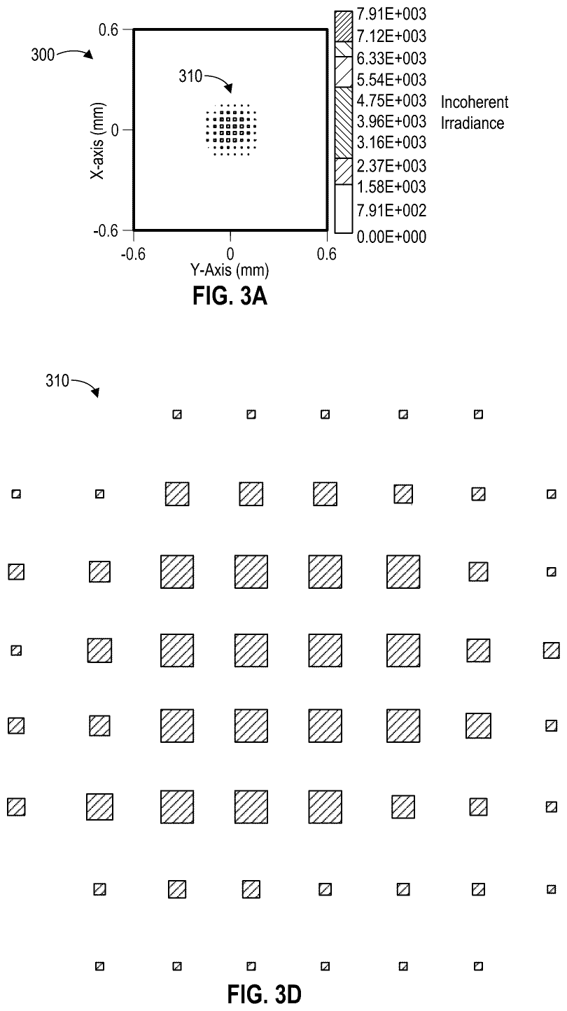

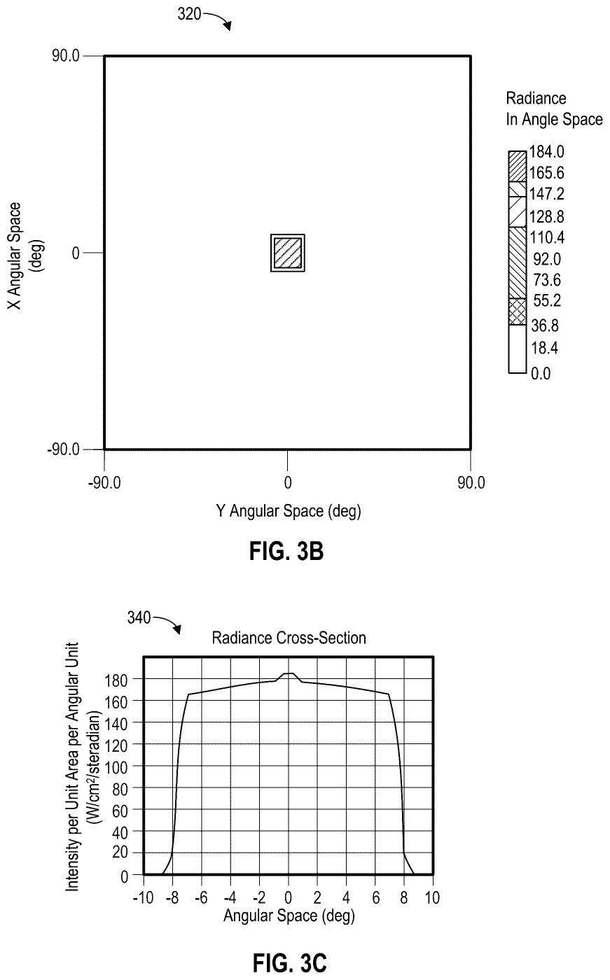

FIG. 3A is a graph 300 showing a simulated spatial power distribution of the laser beam 202 at the output of the MMF 214 (FIG. 2) at a particular point in time. As FIG. 3A shows, there is no single hotspot for power intensity in the MMF 214. Speckles 310 are formed across the end-face that provides the output, at positions that are evenly distributed across this end-face in both the x- and y-directions. As shown in FIG. 3D, which is a zoom-in view of the speckles 310 in FIG. 3A, the spatial distribution of power for the speckles 310 is substantially uniform. The positions of these speckles 310 change over time as the beam position and angles at which the MLA 204 (or alternatively, a DOE) receives the laser beam 202 vary due to the action (e.g., scanning) of the one or more deflection mirrors 118 (FIG. 1). The speckles 310 thus average out over time and substantial spatial uniformity is obtained.

FIG. 3B is a graph 320 showing a simulated angular power distribution of the laser beam 202 at the output of the MMF 214 (FIG. 2). FIG. 3C is a graph 340 showing a corresponding simulated radiance cross-section of the laser beam 202. The cross-section of FIG. 3C is a cross-section through the angular power distribution of FIG. 3B (e.g., at a particular point in x-angular space or in y-angular space in FIG. 3B). FIGS. 3B and 3C show that substantial angular uniformity for the power distribution is obtained in the MMF 214.

The light source 100 (FIG. 1) is a single-channel light source that provides a single laser beam as output. As an alternative to the single-channel light source 100, a multi-channel light source may provide multiple laser beams (e.g., multiple uniform laser beams and/or multiple laser beams with specified shapes) as output.

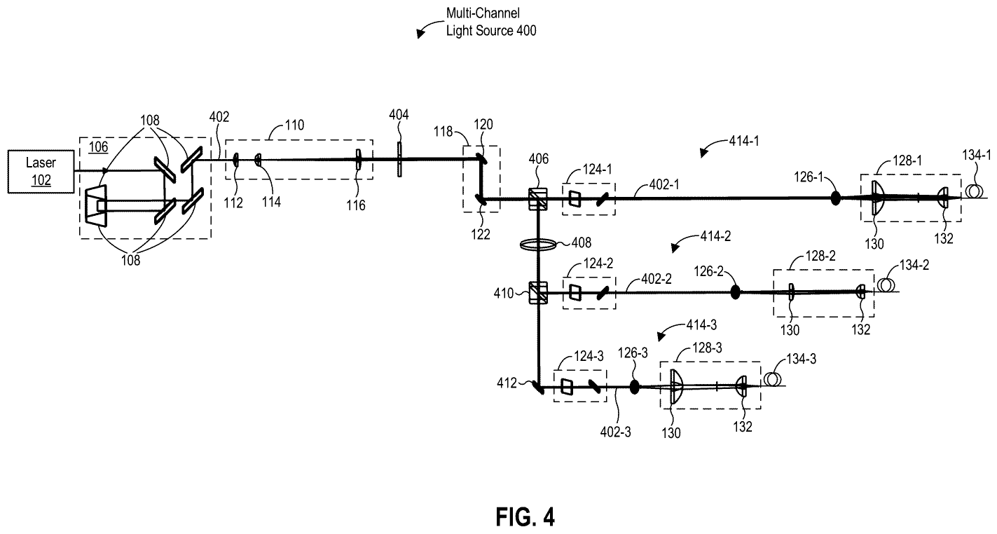

FIG. 4 is a schematic diagram of a multi-channel light source 400 in accordance with some embodiments. The light source 400 includes the laser 102 (FIG. 1), which generates a laser beam 402; the alignment assembly 106 with the plurality of mirrors 108 (e.g., six mirrors 108, or alternatively four or two mirrors 108); the lens assembly 110 with the lenses 112, 114, and 116; and the one or more deflection mirrors 118 (e.g., with the first mirror 120 and the second mirror 122). These components have the same arrangement as in the light source 100 (FIG. 1).

The light source 400 further includes a first half-wave plate 404, a first beam splitter 406, a second half-wave plate 408, and a second beam splitter 410. The first half-wave plate 404 precedes the one or more deflection mirrors 118 (i.e., is disposed somewhere between the laser 102 and the one or more deflection mirrors 118). For example, the first half-wave plate 404 is disposed between the lens assembly 110 and the one or more deflection mirrors 118. The second half-wave plate 408 follows the first beam splitter 406 and is followed by the second beam splitter 410, such that the second half-wave plate 408 is disposed between the first beam splitter 406 and the second beam splitter 410.

The first and second half-wave plates 404 and 408 each adjust the polarization of the laser beam 402 to have either a first polarization, a second polarization, or a mix of the first polarization and the second polarization. In some embodiments, the half-wave plates 404 and 408 are motorized to allow them to be switched into or out of the optical path of the laser beam 402. For example, the half-wave plates 404 and 408 may be mounted on respective motorized rotatable disks that can rotate the half-wave plates 404 and 408 into and out of the optical path. Each rotatable disk may have multiple half-wave plates on it, from which a desired half-wave plate may be selected and positioned in the optical path to provide the desired polarization for the laser beam 402.

The first beam splitter 406 and the second beam splitter 410 each transmit light with the first polarization in a first direction and light with the second polarization in a second direction. Accordingly, the first beam splitter 406 and the second beam splitter 410 each direct the laser beam 402 in accordance with the polarization of the laser beam 402. The first beam splitter 406 directs the laser beam 402 to at least one of a first optical path 414-1 or a second optical path 414-2, in accordance with the polarization of the laser beam 402 as adjusted by the first half-wave plate 404. For example, the first beam splitter 406 transmits light in the laser beam 402 with the first polarization along the first optical path 414-1, thus providing a first laser beam 402-1, and transmits light in the laser beam 402 with the second polarization toward the second half-wave plate 408 and the second beam splitter 410. If the laser beam 402 (or a portion thereof) reaches the second beam splitter 410, the second beam splitter 410 directs the laser beam 402 (or the portion thereof) in accordance with the polarization of the laser beam 402 as adjusted by the first half-wave plate 404 and as adjusted again by the second half-wave plate 408. For example, the second beam splitter 410 transmits light in the laser beam 402 with the first polarization along the second optical path 414-2 and transmits light in the laser beam 402 with the second polarization along a third optical path 414-3 (or vice-versa). The second beam splitter 410 thus provides a second laser beam 402-2 along the second optical path 414-2 and a third laser beam 402-3 along the third optical path 414-3. The first laser beam 402-1, second laser beam 402-2, and third laser beam 402-3 may be referred to as deflected laser beams, because they originate from the laser beam 402 as deflected by the one or more deflection mirrors 118.

The first optical path 414-1 includes first diffractive optics 126-1 to diffract the first laser beam 402-1; a first MMF 134-1 to transmit the first laser beam 402-1 as diffracted by the first diffractive optics 126-1; and a first plurality of lenses 128-1, disposed between the first diffractive optics 126-1 and the first MMF 134-1, to provide the first laser beam 402-1 as diffracted by the first diffractive optics 126-1 to the first MMF 134-1. The first beam splitter 406 is disposed between the one or more deflection mirrors 118 and the first diffractive optics 126-1. The first diffractive optics 126-1 may be a first MLA (e.g., an instance of the MLA 204, FIG. 2) or a first DOE. The first plurality of lenses 128-1 includes instances of the projection lens 130 and the coupling lens 132 (FIG. 1). In some embodiments, these instances of the projection lens 130 and the coupling lens 132 are arranged as shown in FIG. 2, with the first plurality of lenses 128-1 including the first lens 206 as the projection lens 130 and the second lens 210 as the coupling lens 132. The first optical path 414-1 may also include a beam-sampling assembly 124-1 (e.g., a two-window beam-sampling assembly).

The second optical path 414-2 includes second diffractive optics 126-2 to diffract the second laser beam 402-2; a second MMF 134-2 to transmit the second laser beam 402-2 as diffracted by the second diffractive optics 126-2; and a second plurality of lenses 128-2, disposed between the second diffractive optics 126-2 and the second MMF 134-2, to provide the second laser beam 402-2 as diffracted by the second diffractive optics 126-2 to the second MMF 134-2. The second diffractive optics 126-2 may be a second MLA (e.g., an instance of the MLA 204, FIG. 2) or a second DOE. The second plurality of lenses 128-2 includes instances of the projection lens 130 and the coupling lens 132 (FIG. 1). In some embodiments, these instances of the projection lens 130 and the coupling lens 132 are arranged as shown in FIG. 2, with the second plurality of lenses 128-2 including the first lens 206 as the projection lens 130 and the second lens 210 as the coupling lens 132. The second optical path 414-2 may also include a beam-sampling assembly 124-2 (e.g., a two-window beam-sampling assembly).

The first beam splitter 406 is disposed between the one or more deflection mirrors 118 and the second diffractive optics 126-1, in addition to being disposed between the one or more deflection mirrors 118 and the first diffractive optics 126-1. The second half-wave plate 408 is disposed between the first beam splitter 406 and the second diffractive optics 126-2. And because the second half-wave plate 408 is also disposed between the first beam splitter 406 and the second beam splitter 410, the second beam splitter 410 is disposed between the first beam splitter 406 and the second diffractive optics 126-2.

The third optical path 414-3 includes third diffractive optics 126-3 to diffract the third laser beam 402-3; a third MMF 134-3 to transmit the third laser beam 402-3 as diffracted by the third diffractive optics 126-3; and a third plurality of lenses 128-3, disposed between the third diffractive optics 126-3 and the third MMF 134-3, to provide the third laser beam 402-3 as diffracted by the third diffractive optics 126-3 to the third MMF 134-3. The third diffractive optics 126-3 may be a third MLA (e.g., an instance of the MLA 204, FIG. 2) or a third DOE. The third plurality of lenses 128-3 includes instances of the projection lens 130 and the coupling lens 132 (FIG. 1). In some embodiments, these instances of the projection lens 130 and the coupling lens 132 are arranged as shown in FIG. 2, with the third plurality of lenses 128-3 including the first lens 206 as the projection lens 130 and the second lens 210 as the coupling lens 132. In some embodiments, the third optical path 414-3 further includes a static mirror 412 (e.g., a right-angle mirror), disposed between the second beam splitter 410 and the third diffractive optics 126-3 along the third optical path 414-3, to direct the laser beam 402-3 from the second beam splitter 410 to the third diffractive optics 126-3. The third optical path 414-3 may also include a beam-sampling assembly 124-3 (e.g., a two-window beam-sampling assembly).

The first beam splitter 406 is disposed between the one or more deflection mirrors 118 and the third diffractive optics 126-3, in addition to being disposed between the one or more deflection mirrors 118 and the first diffractive optics 126-1 and being disposed between the one or more deflection mirrors 118 and the second diffractive optics 126-1. The second half-wave plate 408 is disposed between the first beam splitter 406 and the third diffractive optics 126-3, in addition to being disposed between the first beam splitter 406 and the second diffractive optics 126-2. And because the second half-wave plate 408 is also disposed between the first beam splitter 406 and the second beam splitter 410, the second beam splitter 410 is also disposed between the first beam splitter 406 and the third diffractive optics 126-3, in addition to being disposed between the first beam splitter 406 and the second diffractive optics 126-2.

The first beam splitter 406 directs the laser beam 402, as deflected by the one or more deflection mirrors 118, to at least one (e.g., to only one, or to both) of the first optical path 414-1 or the second half-wave plate 408, in accordance with the polarization of the laser beam as adjusted by the first half-wave plate 404. By directing the laser beam 402 to the second half-wave plate 408, the first beam splitter 406 also directs the laser beam 402 toward the second beam splitter 410. The second beam splitter 410 directs the laser beam 402, as deflected by one or more deflection mirrors 118 and directed to the second beam splitter 410 by the first beam splitter 406, to at least one (e.g., to only one, or to both) of the second optical path 414-2 or the third optical path 414-3, in accordance with the polarization of the laser beam 402 as adjusted by the first half-wave plate 404 and the second half-wave plate 408.

The light source 400 may be operated to output one, two, or three substantially uniform (or shaped) laser beams, through adjustment of the polarization of the laser beam 402 by the first half-wave plate 404 and/or the second half-wave plate 408. For example, the first half-wave plate 404 and/or the second half-wave plate 408 may adjust the polarization of the laser beam 402 such that the first beam splitter 406 and/or the second beam splitter 410 direct the entire laser beam 402 to the first optical path 414-1 as the laser beam 402-1, to the second optical path 414-2 as the laser beam 402-2, or to the third optical path 414-3 as the laser beam 402-3. A single beam is thus output from either the first MMF 134-1, or the second MMF 134-2, or the third MMF 134-3. In other examples, the first half-wave plate 404 adjusts the polarization of the laser beam 402 to have a mix of the first polarization and second polarization. The first beam-splitter 406 directs the light with the first polarization to the first optical path 414-1 as the laser beam 402-1, which is ultimately output by the first MMF 134-1 as a uniform (or shaped) beam. The first beam-splitter 406 also directs the light with the second polarization toward the second beam splitter 410. Depending on the polarization adjustment by the second half-wave plate 408 (or lack thereof—the second half-wave plate 408 may be switched out of the optical path), the second beam splitter 410 directs the entirety of the beam it receives to the second optical path 414-2 as the laser beam 402-2 (e.g., if the beam has only the first polarization, or alternatively has only the second polarization), directs the entirety of the beam it receives to the third optical path 414-3 as the laser beam 402-3 (e.g., if the beam has only the second polarization, or alternatively has only the first polarization), or directs the portion of the light it receives with one polarization (e.g., the first polarization) to the second optical path 414-2 as the laser beam 402-2 while directing the portion of the light it receives with the other polarization (e.g., the second polarization) to the third optical path 414-3 as the laser beam 402-3.

The light source 400 has three outputs. A light source with two outputs may be achieved by omitting the second half-wave plate 408, the second beam splitter 410, and the components of the second optical path 414-2. Equivalently, a two-output light source may be achieved by omitting the second half-wave plate 408, omitting the components of the third optical path 414-3, and replacing the second beam splitter 410 with the static mirror (e.g., right-angle mirror) 412. A light source with more than three outputs may be achieved by adding additional half-wave plates, beam splitters, and optical paths.

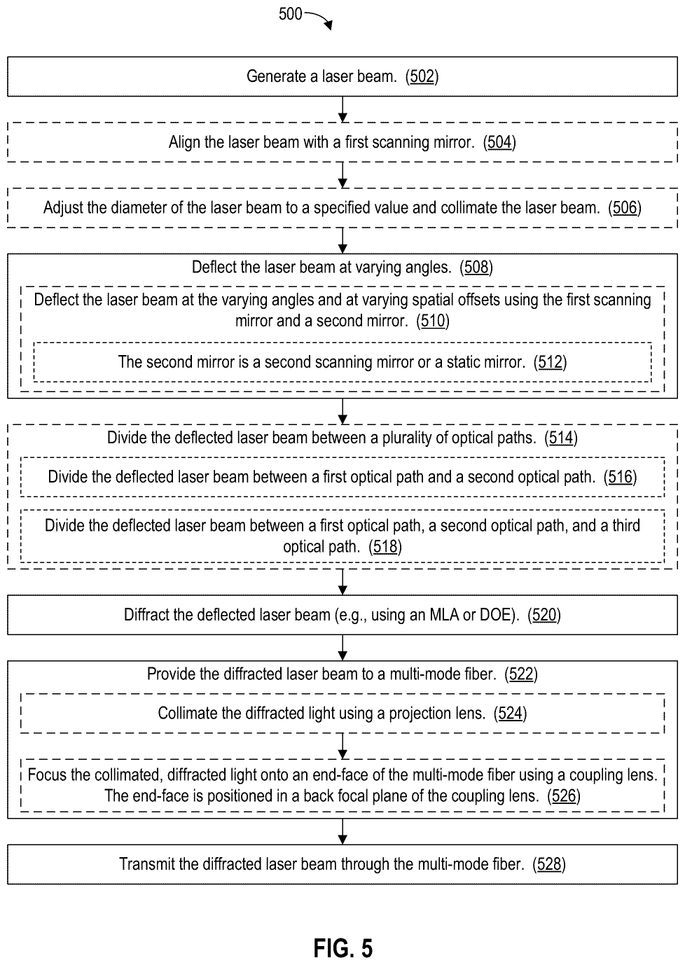

FIG. 5 is a flowchart illustrating a method 500 of optical illumination in accordance with some embodiments. The method 500 is performed, for example, by a single-channel light source (e.g., the light source 100, FIG. 1) or by a multi-channel light source (e.g., the multi-channel light source 400, FIG. 4). The steps in the method 500 are shown in a particular order but may be performed simultaneously. The ordering of the steps in the method 500 is spatial, not temporal.

In the method 500, a laser beam is generated (502). For example, a laser beam 104 (FIG. 1) or 402 (FIG. 4) is generated by the laser 102 (FIG. 1 or 4). The laser beam may be an example of the laser beam 202 (FIG. 2).

The laser beam may be aligned (504) with a first scanning mirror (e.g., with the first mirror 120, FIG. 1 or 4). This alignment is performed, for example, by a beam-alignment assembly 106 (FIG. 1 or 4). This alignment may also align the laser beam with a lens assembly 110 (FIG. 1 or 4).

The diameter of the laser beam may be adjusted (506) to a specified value and the laser beam may be collimated (e.g., by the lens assembly 110, FIG. 1 or 4).

The laser beam is deflected (508) at varying angles (e.g., by the one or more deflection mirrors 118, FIG. 1 or 4). In some embodiments, the laser beam is deflected (510) at the varying angles and at varying spatial offsets using the first scanning mirror (e.g., the first mirror 120, FIG. 1 or 4) and a second mirror (e.g., the second mirror 122, FIG. 1 or 4). For example, the second mirror is (512) a second scanning mirror or a static mirror.

In some embodiments, the deflected laser beam is divided (514) between a plurality of optical paths. For example, the deflected laser beam is divided (516) between a first optical path and a second optical path (e.g., between two of the three optical paths 414-1, 414-2, and 414-3 of the light source 400, FIG. 4) (e.g., between both optical paths of a two-output light source). In another example, the deflected laser beam is divided (518) between a first optical path, a second optical path, and a third optical path (e.g., between the three optical paths 414-1, 414-2, and 414-3 of the light source 400, FIG. 4). Alternatively, the deflected laser beam continues to propagate along a single optical path (e.g., along the single optical path of the light source 100, FIG. 1) (e.g., along one of the three optical paths 414-1, 414-2, and 414-3 of the light source 400, FIG. 4) (e.g., along one of the two optical paths of a two-output light source).

The deflected laser beam is diffracted (520) (e.g., by the diffraction optics 126, FIG. 1) (e.g., by the diffraction optics 126-1, 126-2, and/or 126-3, FIG. 4). For example, the laser beam is diffracted using an MLA (e.g., MLA 204, FIG. 2) or DOE. If the deflected laser beam was divided (514) between a plurality of optical paths, then the portion of the laser beam on each optical path is diffracted by respective diffraction optics (e.g., by respective MLAs and/or DOEs).

The diffracted laser beam is provided (522) to an MMF (e.g., to the MMF 134, FIG. 1) (e.g., to the MMF 214, FIG. 2) (e.g., to one of the three MMFs 134-1, 134-2, or 134-3, FIG. 4). If the deflected laser beam was divided (514) between a plurality of optical paths, then the diffracted laser beam is provided (i.e., respective divided portions of the diffraction laser beam are provided) to multiple MMFs, each in a respective optical path. In some embodiments, the diffracted light is collimated (524) using a projection lens (e.g., the projection lens 130, FIG. 1 or 4) (e.g., the first lens 206, FIG. 2). The collimated, diffracted light is focused (526) onto an end-face of the MMF using a coupling lens (e.g., the coupling lens 132, FIG. 1 or 4) (e.g., the second lens 210, FIG. 2). The end-face is positioned in a back focal plane of the coupling lens.

The diffracted laser beam is transmitted (528) through the MMF. The resulting output from the MMF may be a laser beam with substantial spatial and angular uniformity, or may be a laser beam with a specified shape. If the diffracted laser beam is provided to multiple MMFs, the resulting output from each MMF may be a respective laser beam with substantial spatial and angular uniformity, or may be a respective laser beam with a specified shape.

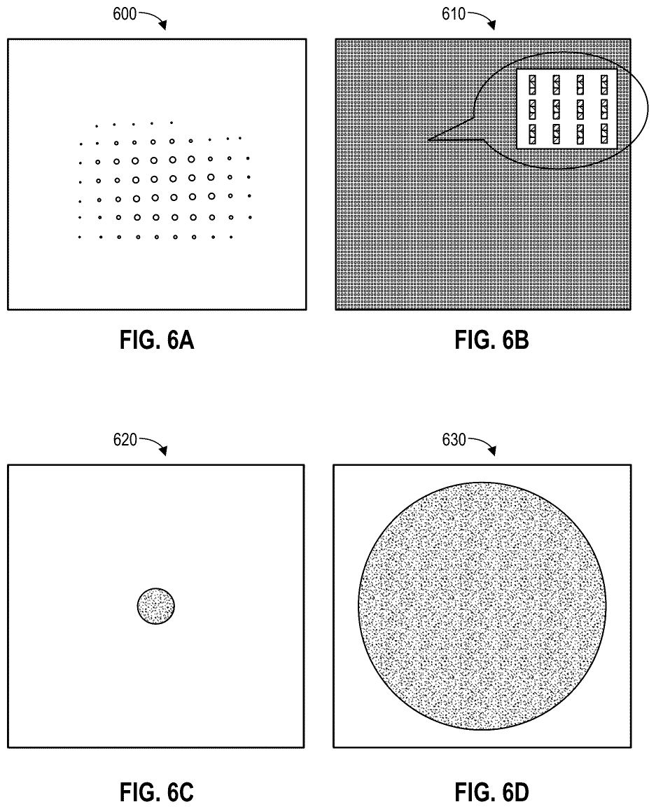

FIGS. 6A-6D show empirical data for an implementation of a single-channel light source 100 (FIG. 1). In this implementation, the laser 102 is a deep ultraviolet (DUV) laser that produces a laser beam 104 with a 266 nm wavelength. The beam-alignment assembly 106 is a two-mirror assembly and is followed by Rochon prism that acts as a polarizer to attenuate the laser beam 104: the Rochon prism deflects a portion of the laser beam 104 away from the optic axis into an aperture stop. The lens assembly 110 enlarges the diameter of the laser beam 104 from ˜0.6 um to ˜2.0 um while maintaining collimation of the laser beam 104. The one or more deflection mirrors 118 are implemented as a single right-angle mirror with variable tilt. The diffraction optics 126 are implemented a single-sided MLA. The MLA and the plurality of lenses 128 are implemented as shown in FIG. 2.

For this implementation, FIG. 6A shows an image 600 of the laser beam 104, as diffracted by the MLA, in the plane of the end-face 216 where coupling into the MMF 214 occurs (i.e., in the back focal plane 212, FIG. 2). The pattern shown in FIG. 6A moves across the core of the MMF 214 as the tilt of the right-angle mirror changes, which avoids hot-spots in the core and improves the lifetime of the MMF 214. FIG. 6B is an image 610 in the Fourier Plane 208 (FIG. 2) showing three different tilts of the right-angle mirror used for the one or more deflection mirrors 118. FIG. 6B shows that the mode amplitudes (i.e., diffraction-order amplitudes) are similar and that by changing the tilt of the right-angle mirror, different modes are injected into the MMF, thus creating substantial angular uniformity over time. FIG. 6C is an image 620 showing the spatial distribution of the laser beam 104 at the far end-face of the MMF 214 for a single tilt of the right-angle mirror. FIG. 6D is an image 630 showing the angular distribution of the laser beam 104 for the single tilt of the right-angle mirror.

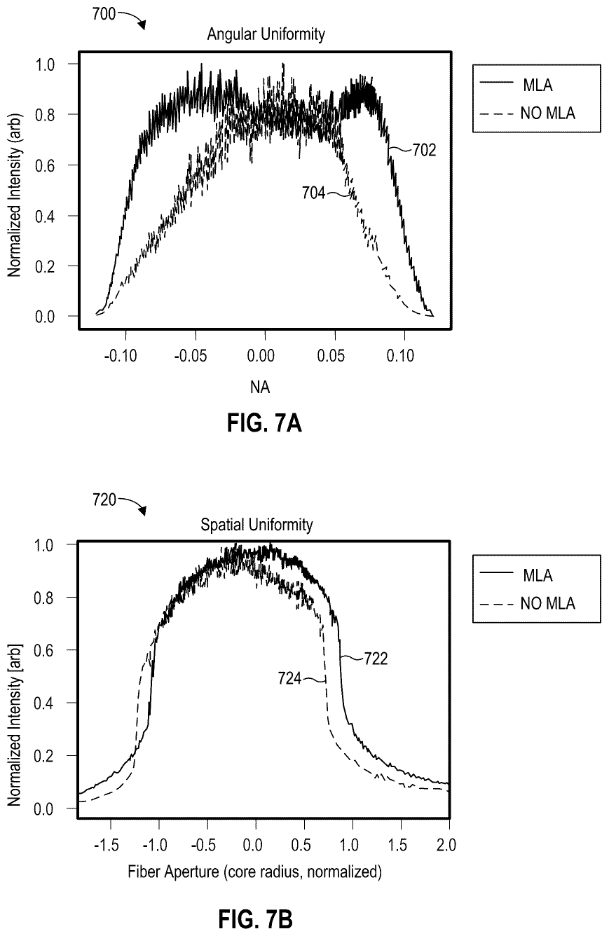

FIGS. 7A and 7B show comparisons of this implementation to a light source with direct coupling of the laser beam into an MMF without an MLA or other diffraction optics. FIG. 7A is a graph 700 comparing angular uniformity for these two cases. As FIG. 7A shows, intensity 702 of the laser beam output for this implementation, with its use of an MLA for diffraction optics, has much better angular uniformity than intensity 704 of a laser beam output in the case of direct coupling without an MLA or other diffraction optics. FIG. 7B is a graph 720 comparing spatial uniformity for these two cases. As FIG. 7B shows, intensity 722 of the laser beam output for this implementation, with its use of an MLA for diffraction optics, has better spatial uniformity than intensity 724 of the laser beam output in the case of direct coupling without an MLA or other diffraction optics. The spatial and angular uniformity of this implementation could be further improved by, for example, using a square MMF instead of a circular MMF, using an improved beam-alignment assembly 106 (e.g., a four-mirror or six-mirror assembly), customizing the MLA, and/or replacing the single-sided MLA with a double-sided MLA or a multiple-spot DOE.

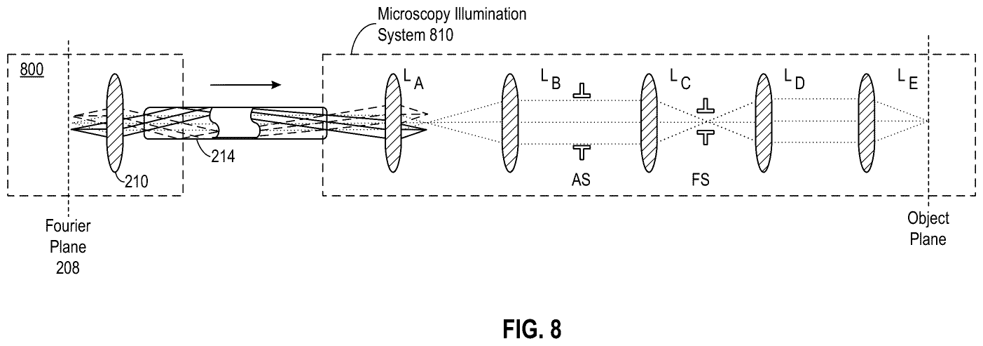

A light source as described herein may be used for microscopy. FIG. 8 shows an extended uniform light source 800 in a Kohler illumination arrangement for microscopy in accordance with some embodiments. The light source 800 is an example of the light source 100 (FIG. 1), with the arrangement of components 200 (FIG. 2). An MMF 214 provides a laser beam from the uniform light source 800 to a microscopy illumination system 810. The laser beam fills up the aperture plane (conjugated to the AS) and the field plane (conjugated to the FS) of the illumination system 810. The aperture plane is conjugated to the AS and the fiber core while the field plane is conjugated to the FS and the Fourier Plane 208. As a result, high-quality imaging is achieved, with the NA being filled properly and the field of view having a balanced amplitude.

Another application for a light source as described herein is in the ultraviolet (UV) cleaning system of a photomask (i.e., reticle) inspection tool. Uniform fields provided by the light source may be projected onto different optics in the tool in a process that removes contamination (e.g., cleans contaminant carbon layers). The contamination otherwise reduces the effectiveness of the tool. Still other applications are possible.

The foregoing description, for purpose of explanation, has been described with reference to specific embodiments. However, the illustrative discussions above are not intended to be exhaustive or to limit the scope of the claims to the precise forms disclosed. Many modifications and variations are possible in view of the above teachings. The embodiments were chosen in order to best explain the principles underlying the claims and their practical applications, to thereby enable others skilled in the art to best use the embodiments with various modifications as are suited to the particular uses contemplated.

What is claimed is:

1. A light source, comprising:
one or more deflection mirrors to deflect a laser beam at varying angles;
diffractive optics to diffract the deflected laser beam;
a multi-mode fiber to transmit the diffracted laser beam; and
a plurality of lenses, disposed between the diffractive optics and the multi-mode fiber, to provide the diffracted laser beam to the multi-mode fiber.

2. The light source of claim 1, wherein the diffractive optics comprise a multi-lens array (MLA) to diffract the deflected laser beam.

3. The light source of claim 1, wherein the diffractive optics comprise a diffractive optical element (DOE) to diffract the deflected laser beam.

4. The light source of claim 1, wherein the multi-mode fiber has a square core.

5. The light source of claim 1, wherein:
the multi-mode fiber comprises an end-face; and
the plurality of lenses comprises:
a projection lens to collect and collimate the diffracted laser beam; and
a coupling lens to focus the collimated, diffracted laser beam onto the end-face, the end-face being positioned in a back focal plane of the coupling lens.

6. The light source of claim 5, wherein:
the projection lens has a first focal length;
the coupling lens has a second focal length;
the projection lens is separated from the coupling lens by a distance along an optic axis of the laser beam equal to the sum of the first focal length and the second focal length; and
the end-face of the multi-mode fiber is separated from the coupling lens by a distance along the optic axis of the laser beam equal to the second focal length.

7. The light source of claim 1, wherein the one or more deflection mirrors comprise a first scanning mirror.

8. The light source of claim 7, wherein the one or more deflection mirrors further comprise a static mirror to receive the laser beam from the first scanning mirror and direct the laser beam toward the diffractive optics.

9. The light source of claim 7, wherein the one or more deflection mirrors further comprise a second scanning mirror to receive the laser beam from the first scanning mirror and direct the laser beam toward the diffractive optics.

10. The light source of claim 1, wherein the diffractive optics are first diffractive optics, the multi-mode fiber is a first multi-mode fiber, and the plurality of lenses are a first plurality of lenses, the light source further comprising:
second diffractive optics to diffract the deflected laser beam;
a second multi-mode fiber to transmit the laser beam as diffracted by the second diffractive optics;
a second plurality of lenses, disposed between the second diffractive optics and the second multi-mode fiber, to provide the laser beam as diffracted by the second diffractive optics to the second multi-mode fiber; and
a first beam splitter disposed between the one or more deflection mirrors and the first diffractive optics, and between the one or more deflection mirrors and the second diffractive optics, wherein:
the first diffractive optics, the first multi-mode fiber, and the first plurality of lenses are disposed along a first optical path; and
the second diffractive optics, the second multi-mode fiber, and the second plurality of lenses are disposed along a second optical path.

11. The light source of claim 10, further comprising a first half-wave plate, preceding the one or more deflection mirrors, to adjust a polarization of the laser beam;
wherein the first beam splitter is to direct the deflected laser beam to at least one of the first optical path or the second optical path, in accordance with the polarization of the laser beam as adjusted by the first half-wave plate.

12. The light source of claim 10, wherein:
the first diffractive optics are selected from the group consisting of a first multi-lens array (MLA) and a first diffractive optical element (DOE); and
the second diffractive optics are selected from the group consisting of a second MLA and a second DOE.

13. The light source of claim 10, further comprising:
third diffractive optics to diffract the deflected laser beam;
a third multi-mode fiber to transmit the laser beam as diffracted by the third diffractive optics;
a third plurality of lenses, disposed between the third diffractive optics and the third multi-mode fiber, to provide the laser beam as diffracted by the third diffractive optics to the third multi-mode fiber; and
a second beam splitter disposed between the first beam splitter and the second diffractive optics, and between the first beam splitter and the third diffractive optics,
wherein the third diffractive optics, the third multi-mode fiber, and the third plurality of lenses are disposed along a third optical path.

14. The light source of claim 13, further comprising:
a first half-wave plate, preceding the one or more deflection mirrors, to adjust a polarization of the laser beam; and
a second half-wave plate, disposed between the first beam splitter and the second beam splitter, to adjust the polarization of the laser beam, wherein:
the first beam splitter is to direct the deflected laser beam to at least one of the first optical path or the second half-wave plate, in accordance with the polarization of the laser beam as adjusted by the first half-wave plate; and
the second beam splitter is to direct the deflected laser beam to at least one of the second optical path or the third optical path, in accordance with the polarization of the laser beam as adjusted by the first half-wave plate and the second half-wave plate.

15. The light source of claim 13, wherein:
the first diffractive optics are selected from the group consisting of a first multi-lens array (MLA) and a first diffractive optical element (DOE);
the second diffractive optics are selected from the group consisting of a second MLA and a second DOE; and
the third diffractive optics are selected from the group consisting of a third MLA and a third DOE.

16. The light source of claim 13, further comprising a static mirror disposed between the second beam splitter and the third diffractive optics along the third optical path, to direct the deflected laser beam from the second beam splitter to the third diffractive optics.

17. The light source of claim 1, further comprising:
a laser to generate the laser beam;
a plurality of alignment mirrors, disposed between the laser and the one or more deflection mirrors, to adjust an optical path of the laser beam to direct the laser beam toward the one or more deflection mirrors; and
a lens assembly, disposed between the plurality of alignment mirrors and the one or more deflection mirrors, to adjust the diameter of the laser beam to a specified value and to collimate the laser beam.

18. An optical-illumination method, comprising:
generating a laser beam;
deflecting the laser beam at varying angles;
diffracting the deflected laser beam;
providing the diffracted laser beam to a multi-mode fiber; and
transmitting the diffracted laser beam through the multi-mode fiber.

19. The method of claim 18, wherein deflecting the laser beam comprises deflecting the laser beam at the varying angles and at varying spatial offsets using a first scanning mirror and a second mirror.

20. The method of claim 18, further comprising dividing the deflected laser beam between a first optical path and a second optical path, wherein:
the multi-mode fiber is a first multi-mode fiber or a second multi-mode fiber;
the first optical path comprises first diffractive optics that diffract the deflected laser beam, the first multi-mode fiber, and a first plurality of lenses to provide the laser beam as diffracted by the first diffractive optics to the first multi-mode fiber; and
the second optical path comprises second diffractive optics that diffract the deflected laser beam, the second multi-mode fiber, and a second plurality of lenses to provide the laser beam as diffracted by the second diffractive optics to the second multi-mode fiber.

21. The method of claim 18, further comprising dividing the deflected laser beam between a first optical path, a second optical path, and a third optical path, wherein:
the multi-mode fiber is a first multi-mode fiber, a second multi-mode fiber, or a third multi-mode fiber;
the first optical path comprises first diffractive optics that diffract the deflected laser beam, the first multi-mode fiber, and a first plurality of lenses to provide the laser beam as diffracted by the first diffractive optics to the first multi-mode fiber;
the second optical path comprises a second beam splitter, second diffractive optics that diffract the deflected laser beam, the second multi-mode fiber, and a second plurality of lenses to provide the laser beam as diffracted by the second diffractive optics to the second multi-mode fiber; and
the third optical path comprises third diffractive optics that diffract the deflected laser beam, the third multi-mode fiber, and a third plurality of lenses to provide the laser beam as diffracted by the third diffractive optics to the third multi-mode fiber.
